(19) United States
(12) Patent Application Publication
(10) Pub. No.: US 2019/0092127 A1
(43) Pub. Date: Mar. 28, 2019

(54) Temperature Remediation in Unattended Vehicles

(71) Applicant: Hien Nguyen, Ladylake, FL (US)

(72) Inventor: Hien Nguyen, Ladylake, FL (US)

(21) Appl. No.: 16/140,221

(22) Filed: Sep. 24, 2018

Related U.S. Application Data
(60) Provisional application No. 62/562,033, filed on Sep. 22, 2017.

(51) Int. Cl. B60H 1/00; B60W 10/30; B60K 28/04

(52) U.S. Cl. CPC B60H 1/00742; B60W 10/30; B60K 28/04; B60R 21/01512; B60H 1/00792; G01K 2201/02; B60L 2240/34; B60H 1/0075

(57) ABSTRACT

A temperature remediation and alarm system for assisting helpless occupants of a vehicle, comprising a portable wearable device to be worn by the helpless occupant, and a vehicle installed device for, inter alia, starting the vehicle's engine, climate control system and alarm system prior to an unsafe temperature being reached when the helpless occupant is left unattended.

### CROSS REFERENCE TO RELATED APPLICATION

This application claims the benefit of U.S. Provisional Application No. 62/562,033 filed Sep. 22, 2017 and entitled, Temperature Remediation In Unattended Vehicles.

### FIELD OF THE INVENTION

The subject invention relates generally to child and pet safety, and more particularly to systems and methods for preventing unsafe temperatures in unattended vehicles for the protection of helpless occupants confined therein.

### BACKGROUND OF THE INVENTION

Each year a number of children and pets die because they are left in vehicles subject to reaching unsafe temperatures for a prolonged period of time. Temperature in a closed car rises rapidly. For example, a car sitting in the sun on a 75-degree day can heat up to 100 degrees within a half-hour. Infants and small children are particularly susceptible to dehydration in hot vehicles and may relatively quickly slip into a comatose state or even worse, suffer a deadly heat stroke. A child can heat up as much as five times faster than an adult. Heat stroke can occur when the body's internal temperature rises above 104 degrees Fahrenheit. Just as with people, heat stroke in pets can cause nausea, loss of consciousness, irreparable brain damage, and death. Pets, more so than humans, are susceptible to overheating when left unattended in vehicle. These tragic incidents typically occur when a driver leaves the car to run a quick errand, forgetting the child or pet is in the car. Once distracted, parents and other caretakers can completely forget that they've left their children unattended.

Heretofore, a variety of systems and methods have been developed which seek to prevent overheating of non-operator vehicle occupants left unattended. Such systems and methods typically involve the employment of a passenger occupant detection apparatus coupled to an alarm to bring the unattended occupant to the attention of the vehicle operator, people in the vicinity of the vehicle who can render aid, or remote parties such as emergency personnel. The detection apparatus take the form of, for example, pressure sensors, belt clip sensors, CO2 sensors, motion detection devices, proximity sensors and sound detection devices which are used to prevent the alarm from being triggered when no occupant is in the vehicle. In short, these solutions rely on third party intervention to rescue the helpless occupant. They do nothing to remediate the unsafe condition. Moreover, some are limited to occupants of child seats or occupants who are sitting on a pressure sensitive pad, but would not work if a child or pet is not activating such sensor which could occur if the child or pet was on the vehicle floor, in a cargo area such as the rear of an SUV or crawled behind the seats of a family van, for instance. Some such systems will only work if the vehicle has GPS or modern onboard computers. U.S. Pat. No. 9,424,728 issued to Rambadt et al. in 2016 provides a rather comprehensive summary of many such systems and methods of the prior art and itself is limited to alerting the vehicle operator or user selected contacts that an infant is in a carrier inside of the vehicle.

Other proposed solutions employ sensors for the detection of the unsafe temperature inside the vehicle to trigger an alarm if the occupant is detected within the vehicle. For example, U.S. Pat. No. 5,451,930 shows a combination of alarm which is triggered when the door of a vehicle is ajar, the temperature of the vehicle interior reaches a certain level, or the occupant of the vehicle triggers the alarm to indicate an emergency. U.S. Pat. No. 5,659,289 discloses a canine alert system which operates a pager or beeper is based on temperature sensing, air conditioning failure and engine stall. U.S. Pat. No. 5,793,291 (Thornton) provides a system using a motion detector and a temperature detecting element coupled to a NOR gate. The system uses the motion detector to determine if person is in an automobile, and the temperature detector to determine if an extreme temperature also exists. If both conditions exist, it sounds the automobile horn. A possible problem with this system is children may be sleeping and making little or no motion while still at risk. U.S. Pat. No. 6,028,509 (Rice) describes a system that uses a temperature measuring circuit which provides an output signal when a particular high temperature is sensed, and a sound sensor which is adjusted to detect the high-pitched sounds emitted by a child. The signals for these sensing devices are received by an AND gate and when both the high temperature is detected and the sounds of a child the system provides an alarm. A possible problem with this system is children may be sleeping and making little or no sound while still at risk. U.S. Pat. No. 7,701,358 (White et al.) teaches a vehicle warning system with a temperature detector sensing vehicle interior temperature. The detector has an alarm setpoint. The system also has a childseat occupancy status detector switch that determines occupancy status of a child car seat or seats in the vehicle. If the temperature detector senses a temperature above the alarm setpoint and the childseat occupancy status detector switch senses the child car seat is occupied, an alarm signal device provides an alarm signal to warn that a child in an unsafe situation. The system may be turned off to prevent annoyance alarms, but turning the system off activates a warning signal. Here again, however, such systems and methods are not directed to correcting the unsafe condition itself.

Some systems and methods have been devised that attempt to correct the unsafe temperature condition rather than merely employing alerts. They typically involve installing one or more thermal sensors in the vehicle. One such invention is described in U.S. Pat. No. 5,311,746 which teaches a system that triggers the ventilation system to purge the air in the vehicle when high temperatures (i.e., those above a preselected limit) are detected. Purging the warm air from the vehicle interior, however, would not necessarily lower the temperature sufficiently to achieve a safe environment for the occupant, particularly when direct sunlight is heating the vehicle roof and interior surfaces.

U.S. Pat. No. 5,949,340 issued to Rossi describes a system with an automobile infant seat occupancy sensor of the switch, optical detector, heat detector, or weight detector type, that provides a reminder signal to fasten the safety harness on the seat. When the ignition of the automobile is turned off, the system provides an alarm to remind that the seat is still occupied. Also described is an embodiment that incorporates a vehicle interior temperature sensor. This embodiment may perform various operations to alleviate harm coming of the seat occupant such as starting the vehicle air conditioning, opening the windows, or transmit a message to a remote location. The Rossi system, however, only protects infant occupants in a child seat.

Accordingly, there is a need for a solution that not only provides an alert to vehicle operators and third parties that a helpless occupant has been left unattended in a vehicle before an unsafe temperature has been reached, but that also prevents the unsafe condition from occurring by activating temperature control components in the vehicle. Moreover, there is a need for such a solution that is not limited to benefiting only occupants of child seats, that does not require a vehicle installed sensor to detect the presence of a helpless occupant, that is not limited to use in vehicles with GPS, onboard computers or power windows, and that is not susceptible to false alarms.

### SUMMARY OF THE INVENTION

Embodiments of the present invention solve many of the problems and/or overcome many of the drawbacks and disadvantages of the prior art by providing systems and methods for controlling vehicle cabin temperatures before they reach unsafe conditions for unattended helpless occupants.

Embodiments of the present invention may include systems and methods for automatic starting of vehicles and their temperature control systems in addition to sounding of alarms and sending notifications to third parties. The systems and methods of the subject invention include a portable and wearable device (“PWD”) to be worn by or attached to a child, pet or other helpless occupant, and a vehicle installed device (“VID”). The PWD includes a temperature sensor and is capable of wireless communication with the VID when vehicle cabin temperature rises above or falls below a preset limit. The VID includes a controller connected to one or more systems of the vehicle including, but not limited to, the lights, horn and alarm system, door locks, windows, the phone and navigation systems for sending out alerts and identifying the location of the vehicle, the ignition system for starting the vehicle and to temperature control components either directly or via the vehicle's onboard computer when available for regulating cabin temperature and bringing it into a safe condition for the occupants until help arrives.

In one embodiment, the subject invention is a temperature remediation and alarm system for assisting helpless occupants of a vehicle, comprising a portable wearable device having attachment means for removable attachment to at least one helpless occupant of a vehicle; the portable wearable device comprising a power source, and a temperature sensor in electronic communication with a controller which in turn is in electronic communication with a transmitter, the temperature sensor, controller and transmitter each being powered by the power source; the controller being adapted for receiving ambient temperature from the temperature sensor and for causing the transmitter to transmit a message signal when the ambient temperature falls outside of a preset range compatible with life of the helpless occupant; and a vehicle installed device for mounting within the vehicle; the vehicle installed device comprising a processor, at least one receiver in wireless communication with the transmitter and in electronic communication with the processor, the processor being adapted for electronic communication with and control of at least the vehicle's alarm system, ignition system and climate control system; whereby the processor will activate that vehicle ignition system to start the vehicle, will activate the vehicle climate control system to restore ambient temperature to within said present range, and will activate the vehicle alarm to alert bystanders in the vicinity.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a vehicle temperature control and alert system for preventing extreme temperatures within passenger and storage areas of a vehicle for the protection of helpless occupants therein, the system comprising a portable wearable device attached to a person, pet or other being or article to be protected from extreme temperature conditions, and a vehicle installed device responsive to the wearable device by selectively commanding activation of the vehicle ignition, temperature control equipment, onboard car alarm and communication systems and other vehicle components including lights, horn and windows.

Another object of the present invention is to provide such a vehicle temperature control and alert system wherein the vehicle installed device is sound activated by the portable wearable device.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a block diagram of a vehicle system incorporating an embodiment of the subject vehicle occupant safety system; and

FIG. 2 is a diagrammatic view of a vehicle occupant safety system of the subject invention employed within a motor vehicle.

### DETAILED DESCRIPTION OF THE PREFERRED EMBODIMENT

At the outset, it should be clearly understood that like reference numerals are intended to identify the same structural elements, portions or surfaces consistently throughout the several drawings figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. The figures provided herewith are for explanation purposes to persons ordinarily skilled in the art and that the drawings are not necessarily drawn to scale.

In addition, reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples.

Embodiments in accordance with the present invention may be embodied as a system, method or apparatus. Accordingly, the present invention may take the form of an entirely hardware embodiment or an embodiment combining software and hardware aspects that may all generally be referred to herein as a “system.”

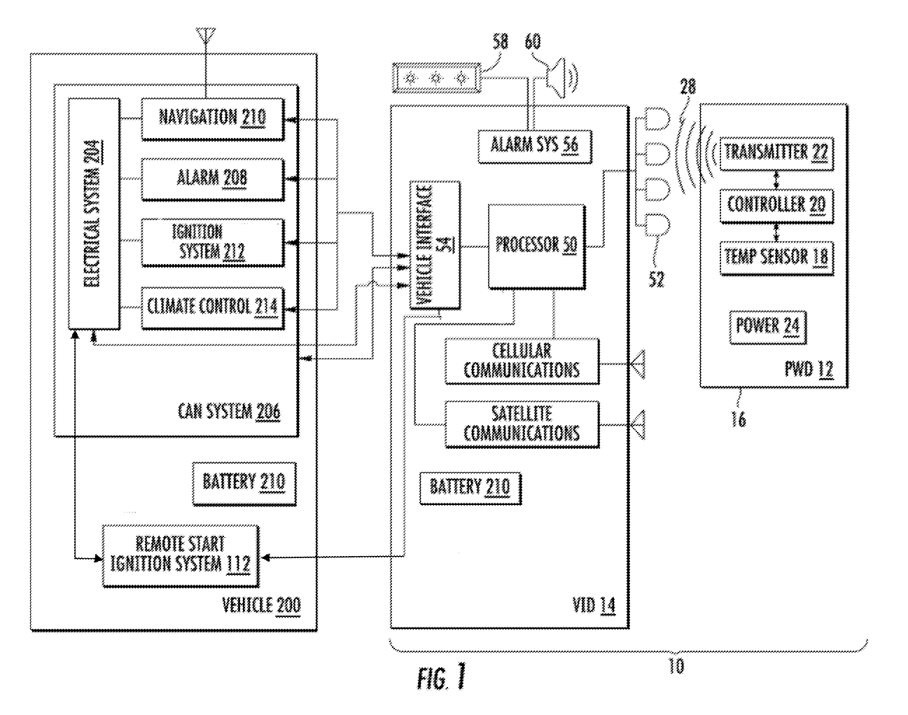

Referring now to the drawings, and particularly to FIG. 1, there is shown a block diagram of a vehicle system 200 incorporating an embodiment of the subject vehicle occupant safety system, designated generally by reference number 10. Vehicle occupant safety system 10 is comprised of two primary components; a portable and wearable device (“PWD”) 12 to be worn by or attached to an infant, child, handicapped or incapacitated individual, pet, animal or other vehicle occupant who is unable to exit the vehicle on their own volition (each a “helpless occupant 300”, together “helpless occupants 300”), and a vehicle installed device (“VID”) 14 which may be installed or mounted in any location in vehicle 200, such as in a trunk, under a seat, in a glovebox, or on a dashboard.

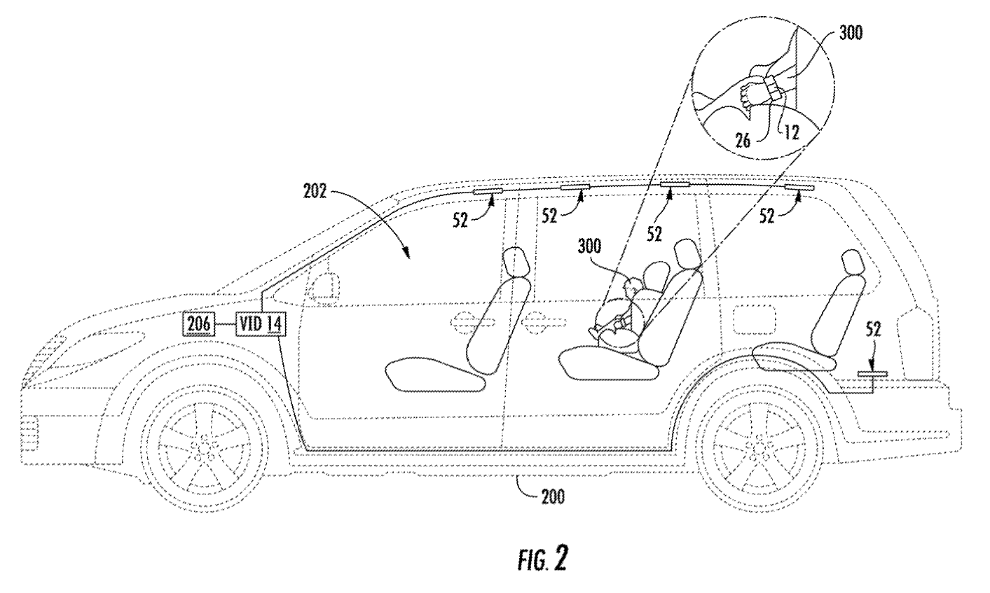

With additional reference to FIG. 2, PWD 12 includes a housing 16 that houses a thermally sensitive sensor 18 (aka “temperature sensor”) in electronic communication with a controller 20 which in turn is in electronic communication with a transmitter 22, and a PWD power source 24 such as a replaceable or rechargeable battery or a storage capacitor. Example temperature sensors include thermistors, RTD's, IC-temperature sensors and thermocouples. Controller 20 may be any type of controller desired, such as a microprocessor configured by software stored in a memory, a microcontroller, a PLA, hardwired circuitry, etc. PWD power source 24 provides power to temperature sensor 18, controller 20 and transmitter 22. Temperature sensor 18, controller 20, transmitter 22 and power source 24 are all sealed within housing 16 for protection from moisture and other environmental conditions for protection.

In one embodiment, PWD 12 is embedded in or otherwise coupled with a fastener 26 used for removable attachment to the helpless occupant 300. For example, PWD 12 may be integrated with a band or strap similar to a watchband or watchstrap, a bracelet, a necklace, a decorative pin or clip, a dog or cat collar, or any other structure suitable for removable attachment to the helpless occupant provided they are made “child safe.”

Temperature sensor 18 detects ambient temperature in the vehicle passenger area or “cabin” 202 (when worn by the helpless occupant who is located within vehicle cabin 202) and provides a signal indicative thereof to controller 20. Controller 20 compares the received temperature signal to one or both of a predefined high temperature threshold value and/or a low temperature threshold value defining an acceptable temperature range between these temperature extreme thresholds. Controller 20 performs executable steps, or includes hardwired logic, to operate so that if the ambient temperature within vehicle 200 is outside the acceptable range, controller 20 activates transmitter 22 and causes it to transmit a message signal 28 to VID 14 using a wireless communication protocol. As used herein, the terms “wireless communication” and “wirelessly communicate” broadly refers to a transmission of message signals (or more simply, “signals”) between devices. In addition, as used herein, the term “wireless communication protocol” refers generally to a communications protocol that facilitates transmitting and receiving message signals over a wireless connection. Examples of wireless communication protocols include IR wireless communication, Bluetooth®, Wi-fi, and ZigBee®. However, various embodiments of the invention utilize alternative protocols as herein described for transmitting a message signal 28 from PWD 12 to VID 14.

VID 14 and its components are powered by VID power source 50 which may be a battery or a battery coupled to another power source such as the vehicle battery 206. VID 14 includes a processor 50 which may be a general use processing device having software programmed to perform executable steps to control various systems of vehicle 200 as described herein, or may be a specially designed circuit or device, such as an application specific integrated circuit (ASIC), that is particularly designed for use in vehicle occupant safety system 10. Processor 50 may use firmware or software, such as an operating system, for control and operation. Firmware, software and other data may be stored in various devices or media (not shown) including random access memory, read only memory, electrically erasable programmable memory (EEPROM) devices, or other storage devices, such as magnetic media.

VID 14 further includes one or more peripheral receivers 52 in electronic communication with processor 50. Each receiver is installed in the passenger compartment (“cabin”) 202 of vehicle 200, and in other areas of the vehicle capable of being occupied by the helpless occupant such as a trunk or rear storage area of a van or SUV, preferably in proximity to such areas where a helpless occupant may be present. Each receiver 52 and adapted to receive message signal 28 from transmitter 22. A plurality of receivers 52 is preferred such that message signal 28 will be received by at least one such receiver no matter where in the vehicle the helpless occupant wearing PWD 12 is located. As may be appreciated, vehicle cabins with relatively greater volumes, such as vans, minivans or SUVs for instance, will require a greater number of receivers than vehicles with smaller cabin volumes.

Message signal 28 acts as a trigger prompting VID 14 to cause vehicle 200 to carry out certain actions including, but not limited to activating a local alarm, sending alerts to remote third parties and performing remedial actions such as unlocking doors, raising or lowering windows, starting the engine and operating vehicle temperature control devices to prevent the interior of the vehicle cabin from reaching an unsafe condition. More specifically, each receiver 52 that receives the message signal 28 provides an output to processor 50 which in turn performs executable steps, or includes hardwired logic, to carry out the desired alarm, alert and remedial actions.

Processor 50 causes the above described alarm, alert and remedial actions to be carried out, either sequentially, simultaneously or as programmed, by: 1) interfacing with select vehicle components directly via one or more vehicle interfaces 54, 2) interfacing with select vehicle components indirectly through the vehicle electrical system 204 to which they are connected via the one or more vehicle interfaces 54, 3) interfacing with select vehicle components indirectly through an available port or data bus of their respective electronic control units (ECUs) together comprising the vehicle's Controller Area Network (CAN) system 206 (if so equipped) via the one or more vehicle interfaces 54, or 4) any combination of the foregoing. Each vehicle interface 54 allows VID 14 generally, and processor 50 in particular, to interact with the desired vehicle components and command their operation.

In an embodiment, processor 50 is in direct or indirect electronic communication with vehicle alarm components 208 via an interface 54. Processor 50 initiates a local alarm by commanding activation of alarm components 208 including, for example, activation of interior and exterior vehicle lights, horn and a vehicle alarm system in order to get the attention of people in the area of the vehicle who can render aid or call for help. In one embodiment, VID 14 includes an on-board alarm system 56 in electronic communication with processor 50. On-board alarm system can include one or more peripheral lights 58 which can be mounted to the exterior of the vehicle such as on the roof. In an embodiment, lights 58 can be a specific color which, through consumer education, can be associated with a child or pet being left unattended in a vehicle subject to unsafe temperatures. Alarm system 56 may also include an audio component adapted to broadcast an audible alarm via a peripheral speaker 60 which is also mounted to the vehicle. The audible alarm can be in the form of a pre-recorded or programmed repeating verbal message such as “Child or Pet Requires Assistance.”

To facilitate evacuation of the helpless occupants 300 from the vehicle cabin 202 by alarm responders, in one embodiment processor 50 commands the unlocking of door locks and/or the lowering of vehicle windows.

In an embodiment, processor 50 is in direct or indirect electronic communication with vehicle navigation system 210 via an interface 54. Processor 50 commands the cellular/mobile telephone device or satellite communication device components of the navigation system to initiate alerts to one or more remote parties including the vehicle operator/owner and emergency call center personnel such as 911 operators or private emergency monitoring companies such as OnStar®. Some vehicle navigation systems also include a geographic position locating system such as a GPS, an inertial navigation system or a terrestrial-based radio navigation system such as LORAN, to identify the vehicle location by its coordinates. In such cases, the vehicle location can also be furnished to the emergency monitoring companies and call centers. In an embodiment, VID 14 may include on-board cellular and/or satellite communications as shown in FIG. 1, as well as locating systems (not shown), all with the same functionality. In a preferred embodiment the on-board satellite communications system if of the Ku, Ka or E-band type.

In embodiments of the subject invention, processor 50 is in direct or indirect electronic communication with the vehicle ignition system 212 and climate control system 214, comprising an air conditioner (A/C) unit and a heater, via interfaces 54. Processor 50 initiates activation of the vehicle ignition system 212 to start the vehicle engine. In some embodiments, a remote start ignition system 112 is installed within vehicle 200 and in electrical communication with vehicle electrical system 204. In such embodiments, processor 50 initiates activation of the remote start ignition system 112 which in turn activates the vehicle ignition system 212. Processor 50 further initiates activation of the climate control system 214 and, based on feedback sent from vehicle temperature sensors, commands climate control system to lower or raise the cabin temperature to restore it to within acceptable limits. In most vehicles, there is no way to run the A/C unit without running the engine because to make the A/C work, it requires a compressor to act on the refrigerant, and the compressor is powered by the engine, not the battery. Accordingly, a priority task of the subject vehicle occupant safety system 10 is to turn on the vehicle engine as well as the temperature control system as soon as temperature sensor 18 detects that ambient cabin temperature is outside of the acceptable range for the purpose of bringing the temperature back into acceptable limits before the cabin temperature becomes unsafe for the unattended occupants until help arrives.

An important aspect of the subject invention is the manner in which PWD 12 communicates message signal 28 to VID 14. In one embodiment, transmitter 22 of PWD 12 is of the type capable of producing infrared, microwave or radio frequency signals to provide communication between the transmitter 22 and a receiver 52 of VID 14. Message signal is modulated using analog or composite (digital) modulation to create a unique signature recognizable by VID 14. Analog-modulation includes amplitude-modulation, frequency-modulation, phase-modulation and pulse-modulation. Modulation is important because it is the information-carrying part of the signal. In one preferred embodiment, however, transmitter 22 may be in the form of a buzzer (transducer), sound generator or speaker triggered by controller 20 to produce an acoustic message signal 28 (meaning a signal in the form of a sound wave. For clarity, sound waves are mechanically produced waves not part of the electromagnetic spectrum. Sound waves are not RF, although an RF signal can have the same frequency as a sound wave. The sound wave is also modulated to possess a unique identifiable frequency profile recognizable which processor 50 is designed or programmed to recognize. Using sound as opposed to an electromagnetic signal is more secure because hackers cannot discretely attempt to steal the vehicle with electromagnetic car key sniffing and mimicking devices which are employed by more sophisticated car thieves. Moreover, unlike EM signals which could trigger temperature remediation and alarm systems of the subject invention that are installed in other vehicles within the range of such signals, acoustic signals are substantially confined to the vehicle's cabin or other interior spaces that a helpless occupant wearing PWD 12 could occupy, thereby mitigating against accidental activation of the same technology in nearby vehicles.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto. All patents, patent applications, provisional applications, and publications referred to or cited herein, or from which a claim for benefit of priority has been made, are incorporated herein by reference in their entirety to the extent they are not inconsistent with the explicit teachings of this specification.

What is claimed as being new, useful and desired to be protected by Letters Patent of the United States is as follows:

1. A temperature remediation and alarm system for assisting helpless occupants of a vehicle, comprising:
a. a portable wearable device having attachment means for removable attachment to at least one helpless occupant of a vehicle; said portable wearable device comprising a power source, and a temperature sensor in electronic communication with a controller which in turn is in electronic communication with a transmitter; said temperature sensor, said controller and said transmitter being powered by said power source; said controller being adapted for receiving ambient temperature from said temperature sensor and for causing said transmitter to transmit a message signal when the ambient temperature falls outside of a preset range; and
b. a vehicle installed device for mounting within the vehicle; said vehicle installed device comprising a processor, at least one receiver in wireless communication with said transmitter and in electronic communication with said processor, said processor being adapted for electronic communication with and control of at least the vehicle's alarm system, ignition system and climate control system;
whereby said processor will activate that vehicle ignition system to start the vehicle, will activate the vehicle climate control system to restore ambient temperature to within said present range, and will activate the vehicle alarm.

2. The temperature remediation and alarm system of claim 1, wherein said message signal is acoustic.
